(19) United States
(12) Patent Application Publication
(10) Pub. No.: US 2003/0053655 A1
(43) Pub. Date: Mar. 20, 2003

(54) Digital data monitoring and logging in an ITV system

(76) Inventors: Samuel T. Barone JR., Culver City, CA (US); John Kelly King, Longwood, FL (US)

Correspondence Address: CHRISTIE, PARKER & HALE, LLP, P.O. BOX 7068, PASADENA, CA, 91109-7068, US

(21) Appl. No.: 10/222,704

(22) Filed: Aug. 16, 2002

Related U.S. Application Data
(60) Provisional application No. 60/312,925, filed on Aug. 16, 2001.

(51) Int. Cl. G06K 9/00

(52) U.S. Cl. 382/100; 375/240.27

(57) ABSTRACT

An ITV system that monitors and stores data related to digital video broadcasts. Such data may include digital sound files, image files, subscription data, software programs, television program information, ITV advertising content, and the like. The monitoring system stores information about a pre-determined set of data that is being monitored in a digital video stream, in one or more log files. The log files may then be used to generate a plurality of user defined reports. The reports may be used by broadcasters, cable operators, and content providers, and the like to establish general auditing and billing services.

### CROSS-REFERENCE TO RELATED APPLICATION(S)

This application claims the benefit of U.S. Application Ser. No. 60/312,925 (attorney docket 45364/JEC/M770), filed on Aug. 16, 2001, the content of which is incorporated herein by reference.

### FIELD OF THE INVENTION

The present invention is generally directed to an interactive television (ITV) system and more particularly, to an ITV system that monitors and stores data related to digital video broadcasts.

### BACKGROUND OF THE INVENTION

Traditional television broadcasts include analog video signals that are received by a television antenna, cable set-top-box, satellite receiver, and the like. A particular video signal may include data such as, for example, closed captioning data and interactive television data, generally embedded in the vertical blanking interval (VBI) of the video signal. A transmitting head end may monitor and log data that is transmitted in the VBI for establishing general auditing and billing services.

A next generation type of televisions that are becoming increasingly popular are digital televisions such as, for example, high-definition televisions (HDTV), configured to receive and decode digital video signals. Transmitted along with such digital video signals are different types of digital data that may be desirable for a head end to log and monitor. Such information may be used for billing, financial accounting, and/or other distribution needs. Traditional analog video monitoring systems, however, do not provide the capability of monitoring digital video data. Accordingly, what is desired, is a system for monitoring and logging digital data transmitted with digital video feeds.

### SUMMARY OF THE INVENTION

The present invention is directed to an ITV system that monitors and stores data related to digital video broadcasts. According to one embodiment of the invention, the invention is directed to a method for monitoring data embedded in a video stream where the method includes receiving a video stream including embedded data, monitoring the video stream for the embedded data, storing information on the monitored data, and utilizing the monitored data for generating a report. The report may be financial reports, auditing reports, and the like. The data may include digital sound files, image files, subscription data, software programs, television program information, ITV advertising content, and the like.

According to another embodiment, the invention is directed to a system for monitoring data embedded in a video stream where the system includes a video stream including embedded data, a memory, and a data monitor coupled to the memory. The data monitor monitors the video stream for the embedded data and stores information on the monitored data in the memory for generating a report.

According to a further embodiment of the invention, the data monitor may be invoked from a remote location.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is a schematic block diagram of a digital interactive television system for monitoring and logging data embedded in digital video streams according to one embodiment of the invention;

FIG. 2 is a block diagram of a monitoring system according to one embodiment of the invention; and

FIG. 3 is a schematic block diagram of an exemplary user interface used to access the monitoring system of FIG. 2 according to one embodiment of the invention.

### DETAILED DESCRIPTION OF THE INVENTION

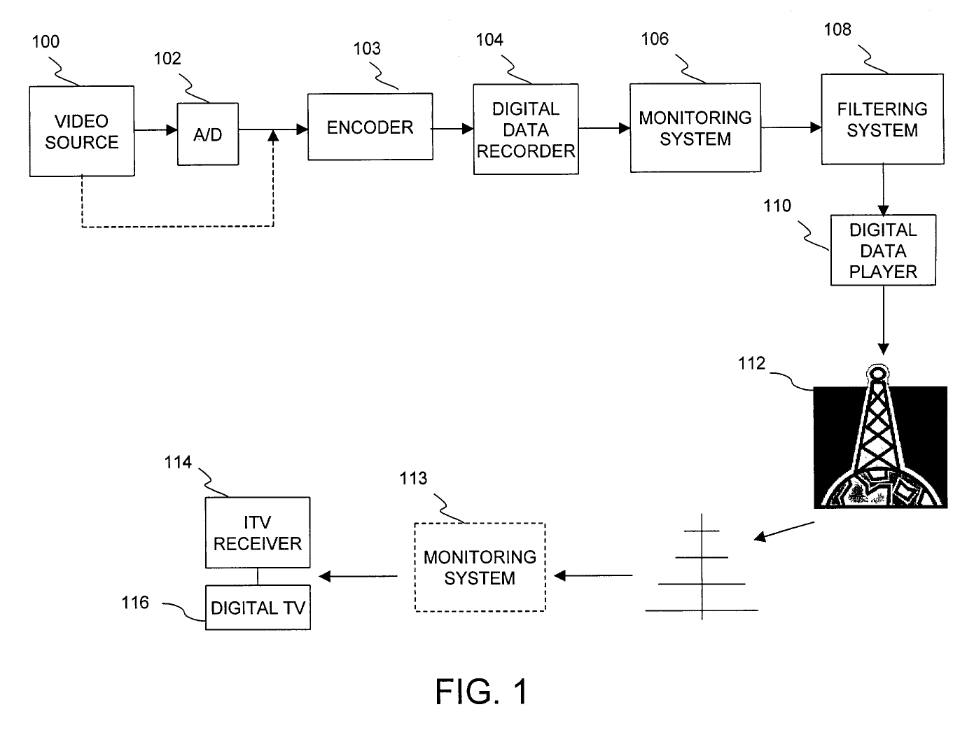

FIG. 1 is a schematic block diagram of a digital interactive television (ITV) system monitoring and logging data embedded in digital video streams according to one embodiment of the invention. The system preferably includes a video source 100 coupled to an analog/digital (A/D) converter 102 for converting analog video signals to digital video signals, such as, for example, MPEG streams. The video source 100 may be an analog camera, VCR, betacam, or the like, providing live or recorded analog video signals to the A/D converter 102. Alternatively, the video source 100 may be a digital video source such as, for example, a digital video camera, DVD player, PC, or CD-ROM player, configured to directly provide the digital video stream. In this scenario, the video feed need not be converted by the A/D converter.

The converted (or original) digital video signal is provided to an encoder 103 for embedding ITV data and other types of digital data into the video signal. The data may be embedded, for example, in an MPEG 2 private data field (or a similar field of additional video formats) of the video portion of the program. The ITV data may take many forms, such as, for example, HTML, XML, JAVA, or JAVA Script commands. In addition to ITV data, additional types of digital data may be embedded in the video stream. Such digital data may or may not be related to the video program that is being transmitted, and may include, without limitation, digital sound files, text files, image files, subscription data, software programs such as gaming programs and/or upgrades to such programs, television program information, soundtrack information, meta tags for storing/searching purposes, ITV advertising content, and the like.

Once the desired data is encoded into a video program, the modified program is output by the encoder 103 and may be recorded by a digital data recorder 104 for subsequent broadcast.

According to one embodiment of the invention, the digital ITV system includes a monitoring system 106 for receiving and monitoring different types of data embedded in the digital video. The monitoring system 106 preferably stores information about a pre-determined set of data that is being monitored, in one or more log files. The log files may then be used to generate a plurality of user defined reports. The reports may be used by broadcasters, cable operators, and content providers, and the like to establish general auditing, billing, financial, accounting, and/or distribution services.

The monitoring system may also generate specific reports that highlight particular data flows and/or particular periods of time that can then be correlated with content schedules for complete auditing trails. For example, the monitoring system 106 may monitor and log a number of MP3 audio files that have passed through a particular video stream in the last 24 hours. In another example, an amount of ITV advertising content that has passed through the video stream may be monitored, and in particular, the amount of advertising for individual advertisers.

In addition to the above, the monitoring system may examine the embedded data for ensuring that it is reliable for being transmitted with the video stream. For example, the monitoring system may maintain and monitor checksum information for different types of data packets to ensure that the data being delivered contains a correct checksum amount.

The digital ITV system illustrated in FIG. 1 may further include a filtering system 108 for filtering the digital video stream in accordance with a pre-defined criteria. For example, the filtering system 108 may filter the data embedded in the video stream prior to broadcast on the basis of a pass list containing data to be broadcast and a don't pass list containing data that is blocked when detected. For example, advertisers may embed ITV data in their commercials. However, if there is no agreement in place between a broadcaster/operator and the advertiser, the broadcaster/operator may want to monitor and block the embedded ITV data from being delivered with the commercials. At the appropriate time, the filtered digital video stream is then broadcast via a digital data player 110 and broadcast station 112.

According to one embodiment of the invention, the digital ITV system includes an optional monitoring system 113 on the receiving side of the broadcast station 112. The optional monitoring system 113 may be incorporated into an ITV receiver 114, antenna, satellite, or the like. The optional monitoring system 113 may be used to monitor a video stream broadcast by the broadcast station 112 to ensure that data associated with the video has not been corrupted during transmission. This may be done, for example, via checksum calculations and/or any other mechanisms conventional in the art. If the video stream is deemed to be reliable, the optional monitoring system 106 may transmit the stream to the ITV receiver 114 for providing to the viewer.

The optional monitoring system 113 may also provide similar functionality as the monitoring system 106 on the broadcast/operator side. However, instead of monitoring different types of data at an aggregate level, the optional monitoring system 113 may monitor data for individual users.

The ITV receiver 114 receives the digital video stream and decodes it for providing the video and associated information to a digital television 116. The digital television may alternatively be replaced by other digital devices capable of displaying video, such as, for example, a personal computer. The ITV receiver 114 further decodes any digital data embedded in the video stream and provides such data to the viewing user. The embedded data may be, for example, ITV data for providing an enhanced version of the video program to the viewer, and/or other types of audio, images, programs, information, and the like provided to the viewer in conjunction with the video program.

It is understood, of course, that FIG. 1 illustrates a block diagram of the digital ITV system without obfuscating inventive aspects of the present invention with additional elements and/or components which may be required for creating the system. These additional elements and/or components, which are not shown in FIG. 1, are well known to those skilled in the art.

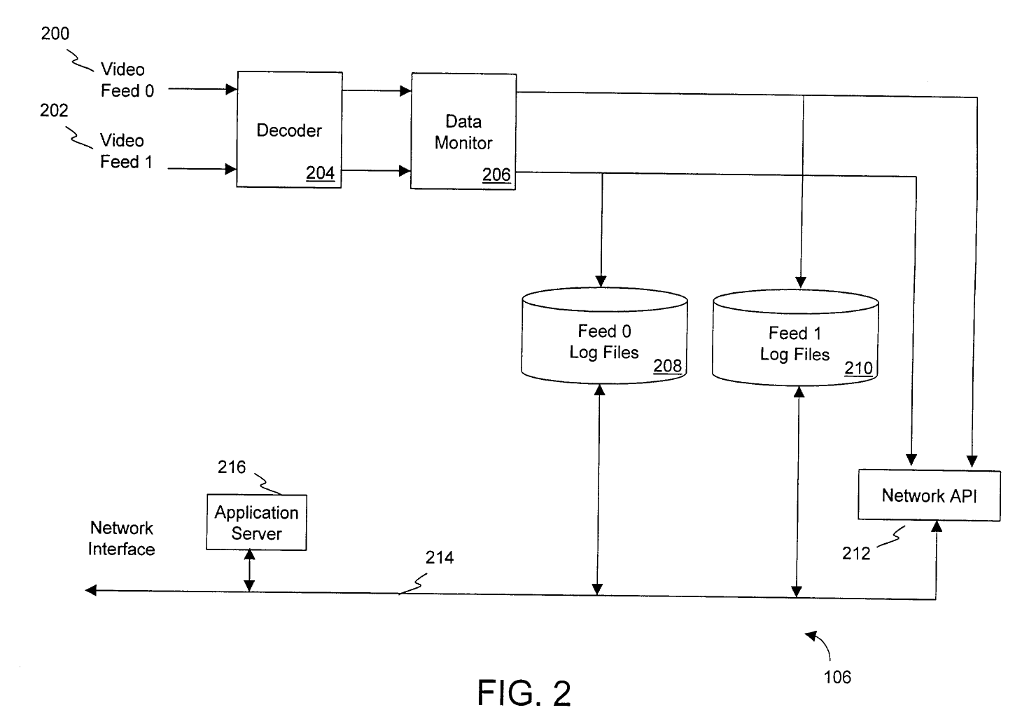

FIG. 2 is a more detailed block diagram of the monitoring system 106 according to one embodiment of the invention. According to the illustrated embodiment, the monitoring system 106 includes an embedded computer system running, for example, a Windows NT operating system. The monitoring system 106 monitors, identifies, and logs different types of data for a plurality of digital video feeds 200 and 202. When no video feed is detected, the monitoring system continues to operate properly by recording that no video is being received.

The monitoring system 106 includes a decoder 204 for decoding the digital data embedded in each video feed 200, 202. The decoded data is transmitted to a data monitor 206 for monitoring, identifying, and logging information on particular types of data. For example, the data monitor 206 may be on the lookout for a particular type of file format, size, data content, data source, meta data, or the like. The monitoring may occur in a real-time or play-back mode. During the play-back mode, the data monitor 206 logs the data in log files 208, 210, and plays back the logged data for a more in-depth analysis.

The data monitor 206 may also be configured to check the integrity of the embedded data. Information on the data being monitored is then stored in the appropriate log files 208, 210. The stored data may then be used for generating user defined reports, such as, for example, general auditing and financial reports.

According to one embodiment of the invention, the monitoring system 106 includes a network interface 214 providing bi-directional communication between an application server 216, a network application programming interface 212, and the logs files 208, 210. In the described embodiment, the application server 216 provides clients or users remote access to the data monitor 206 for allowing an administrator to view and change the monitoring system configuration. In one embodiment, a monitoring system user interface may be in the form of a web page or remote application that is delivered by the application server 216 to a web browser/user agent resident on a remote terminal (not shown) that is accessible to the administrator. In this regard, the administrator uses the remote terminal to access the application server 216. Upon establishing connection with the application server 216, a web page is delivered to the web browser/user agent resident in the remote terminal. According to one embodiment of the invention, the web page may contain a JAVA applet that opens a socket for allowing direct communication with the data monitor 206. In another embodiment, a remote application opens a socket using UDP for direct communication with the data monitor 206. According to a further embodiment of the invention, instead of the JAVA applet, the web browser may be used to communicate with the data monitor 206 via a hypertext transfer protocol (HTTP) in a manner that is conventional in the art.

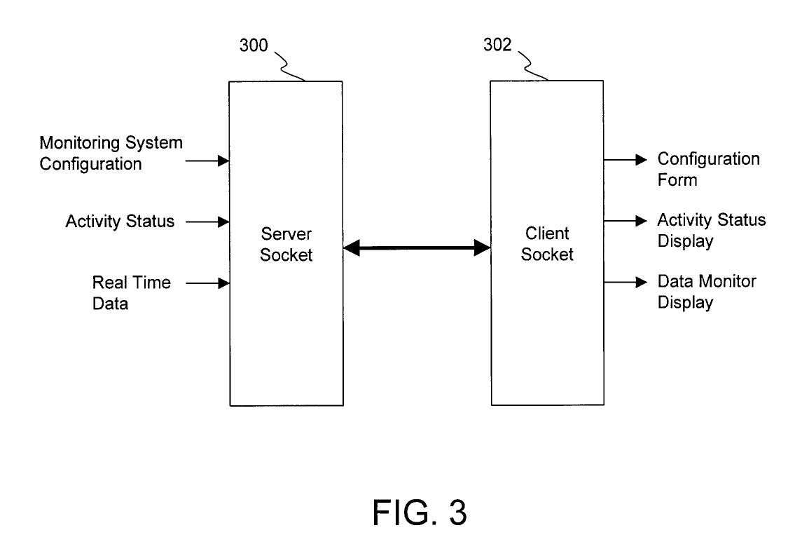

FIG. 3 is a schematic block diagram of an exemplary user interface used to access the monitoring system 106 according to one embodiment of the invention. The user interface preferably includes a server socket 300 and a client socket 302. The server socket 300 is preferably fed with the latest data monitoring information and real time data as it is acquired by the data monitor 206. The client socket 302 is preferably part of the user interface running on the browser resident on the remote terminal.

An exemplary user interface may allow remote users to view real time data and activity information with a plurality of monitoring windows. For example, client computers on the network may download a monitoring application provided by data monitors 206 from the web server 216 and use it to monitor the current data and activity information being acquired by the data monitor.

Although this invention has been described in certain specific embodiments, those skilled in the art will have no difficulty devising variations to the described embodiment which in no way depart from the scope and spirit of the present invention. Moreover, to those skilled in the various arts, the invention itself herein will suggest solutions to other tasks and adaptations for other applications. For example, although the present invention has been described in terms of detecting and logging digital data, a person skilled in the art will understand that the system may be modified to detect data in analog video signals. For example, the system may be configured to detect ITV data and closed captioning data embedded in the vertical blanking interval line (also known as line 21) of an analog video signal. It is the applicant's intention to cover by claims all such uses of the invention and those changes and modifications which could be made to the embodiments of the invention herein chosen for the purpose of disclosure without departing from the spirit and scope of the invention. Thus, the present embodiments of the invention should be considered in all respects as illustrative and not restrictive, the scope of the invention to be indicated by the appended claims and their equivalents rather than the foregoing description.

What is claimed is:

1. A method for monitoring data embedded in a video stream, the method comprising:
receiving a video stream including embedded data;
monitoring the video stream for the embedded data;
storing information on the monitored data; and
utilizing the monitored data for generating a report.

2. The method of claim 1, wherein the monitoring of the video stream comprises monitoring the video stream from a remote location.

3. The method of claim 1, wherein the monitoring of the video stream comprises monitoring a frequency in which the data appears in the video stream.

4. The method of claim 1, wherein the monitoring of the video stream comprises monitoring integrity of the embedded data.

5. The method of claim 1, wherein the video stream is a digital video stream.

6. The method of claim 5, wherein the data is a digital data file.

7. The method of claim 5, wherein the data is interactive television data.

8. The method of claim 1 further comprising filtering the embedded data from the video stream.

9. The method of claim 1 further comprising:
transmitting the video stream to a receiver; and
monitoring the video stream at the receiver.

10. A system for monitoring data embedded in a video stream, the system comprising:
a video stream including embedded data;
a memory; and
a data monitor coupled to the memory, the data monitor monitoring the video stream for the embedded data and storing information on the monitored data in the memory, the monitored data being used for generating a report.

11. The system of claim 10 further comprising means for invoking the data monitor from a remote location.

12. The system of claim 10, wherein the data monitor monitors a frequency in which the data appears in the video stream.

13. The system of claim 10, wherein the data monitor monitors integrity of the embedded data.

14. The system of claim 10, wherein the video stream is a digital video stream.

15. The system of claim 14, wherein the data is a digital data file.

16. The system of claim 14, wherein the data is interactive television data.

17. The system of claim 10 further comprising a filtering system for filtering the embedded data from the video stream.

18. The system of claim 10 further comprising:
a receiver receiving the video stream; and
a second data monitor coupled to the receiver for monitoring the video stream.
